(19) United States
(12) Patent Application Publication
(10) Pub. No.: US 2007/0255861 A1
(43) Pub. Date: Nov. 1, 2007

(54) System and method for providing dynamic network firewall with default deny

(76) Inventors: Michael T. Kain, Collegeville, PA (US); Gary J. Salamon, West Chester, PA (US); Ray R. Tenaglio, Broomall, PA (US); Jon Sistowicz, Philadelphia, PA (US); David A. Dean, Coatesville, PA (US)

Correspondence Address: UNISYS CORPORATION, UNISYS WAY, MAIL STATION: E8-114, BLUE BELL, PA, 19424, US

(21) Appl. No.: 11/498,624

(22) Filed: Aug. 3, 2006

Related U.S. Application Data
(60) Provisional application No. 60/795,463, filed on Apr. 27, 2006.

(51) Int. Cl. G06F 3/00

(52) U.S. Cl. 710/8

(57) ABSTRACT

A computing system having host computer and an I/O processor (IOP) provides firewall services to the host computer. When the host computer and the IOP are initialized, all of the communication ports are reset to a closed state. Application programs are loaded into memory of the host computer for execution and provide the identity of communication ports to be used by the application. The identity of the requested communication ports are used to instruct the IOP to open the communication port to accept network data packets that use the particular port. When the application terminates operation, the communication ports used by the application are closed to provide dynamic control over communication ports. This process ensures that only ports currently used by applications currently executing within the host computer are open without administrator action.

This application claims the benefit from the filing of U.S. Provisional Application Ser. No. 60/795,463, entitled “System and Method For Providing Dynamic Network Firewall with Default Deny” by Kain, et al., filed 27 Apr. 2006, the entire content of which is incorporated herein by reference in its entirety.

### FIELD OF THE INVENTION

The present invention relates generally to techniques for providing network communications between processing devices, and, in particular, to techniques for providing a dynamic firewall having default denial of port access.

### BACKGROUND OF THE INVENTION

Computing systems are routinely connected to communications networks to facilitate remote access to data, processing resources, and application programs. This communications are facilitated by the use of standard communications transport protocols such as TCP, UDP, and similar cooperative data transfer protocols. The computing systems that utilize these transport protocols are typically assigned one or more unique IP addresses that are used assist in automated routing of data packets between these computing systems. The two computing systems communicate with each other using various communications ports that are associated with communications to and from a computing system.

One problem experienced by computing systems using these communications transport protocols relates to issues related to receipt of data packets using a particular port on a system. Application programs running on a computing system expects that a port be open and available to receive data packets if the application is to provide desired services. Unfortunately, computing systems that open ports may become overwhelmed by a large number of data packets directed to the computing system on a particular port. Computing systems typically utilize a firewall to control receipt of data packets by blocking receipt of data packets sent over a communications port that has not been opened for use by the computing system.

Firewalls may be located within a program running with the host computing system being protected as well as may be located within a Input-Output Processing (IOP) device that processes all data packets addressed to the host computing system. Use of these IOP devices provide a benefit to host computing systems by offloading the processing of incoming data packets to a separate device that permits the host to continue to operate regardless of the number of data packets being received. The host computing system will need to process only data packets sent on a port that is open.

Firewalls typically allow ports to be opened for use by an application to be run on the host computing system. These ports are typically statically opened by a system administrator regardless of whether the application program needing a port to be open is running. Changing the state of a communication port to a desired state typically requires an administrator manually initiate the opening and closing of a port on a firewall. As such, ports are typically left open if the port is expected to be used at any time. The open port that is used only by an application not currently being run on the host computing system provides access to the host computing system through the firewall to any other computing system connected to a communications network. The present invention provides a system and method to address these limitations within the prior art.

### SUMMARY OF THE INVENTION

Problems in the prior art are addressed in accordance with the principles of the present invention by providing a dynamic firewall having default denial of port access.

In one embodiment, the present invention is a computing system having host computer and an I/O processor (IOP) that provides firewall services to the host computer. When the host computer and the IOP are initialized, all of the communication ports are reset to a closed state. Application programs are loaded into memory of the host computer for execution and provide the identity of communication ports to be used by the application. The identity of the requested communication ports are used to instruct the IOP to open the communication port to allow network data packets to use the particular port. When the application terminates operation, the communication ports used by the application are closed to provide dynamic control over communication ports. This process ensures that only ports currently used by applications currently executing within the host computer are open.

In another embodiment, the present invention is a method for providing dynamic firewall services to a host computing system. The method initializes all communication ports to a closed state, opens a communication port identified by an application for receipt of client service request packets when the application is loaded into memory of the host computing system for execution, process network connection service request packets received from a client computing system to generate a service response packet as part of the establishment of a connection between a client computing system and the host computing system, opens a communication port to data packets for an open port upon receipt of a client acknowledgement packet in response to the service response packet as part of the establishment of the connection between the client computing system and the host computing system, process all data packets received on the open port to forward the data packets to the application while the connection exists, closes the open port to data packets when the established connection ends, and closes the open port when the application terminates operation.

In another embodiment, the present invention is a machine-readable medium having encoded thereon program code, that when the program code is executed by a host computing system, the host computing system implements a method for providing dynamic firewall service. The method transmits a port command message to an input-output processor (IOP) to initialize communication ports to a closed port state, activating and loading an application into memory, identifies communication ports needed to support the application being loaded into memory of the host computing system, transmits a port command message to the IOP instructing the opening of the identified communication ports needed to support the application, and transmits a port command message to the IOP instructing the closing of the identified communication ports needed to support the application when the application terminates operation.

In another embodiment, the present invention is a machine-readable medium, having encoded thereon program code, that when the program code is executed by a input-output processor (IOP), the IOP implements a method for providing dynamic firewall services to a host computing system. The method receives a port command message from the host computing system to initialize communication ports to a closed port state, receives a port command message that instructs the opening of one or more communication ports identified as supporting an application, receives a data packet sent to the host computing system over a network using a particular communications port, forwards the data packet to the application when the particular communication port identified within the data packet corresponds to an open port, and receives a port command message to the IOP instructing the closing of the identified communication ports needed to support the application when the application terminates operation.

In yet another embodiment, the present invention is an apparatus for providing dynamic firewall services to a host computing system. The apparatus has a distributed firewall module executing within the host computing system for controlling the operation of the IOP using port command messages and an NIC firewall module executing within an input-output processor (IOP) for maintaining a plurality of communications ports associated with communications with a client computing system over a network. The NIC firewall module comprises a host interface module for receiving port command messages from the distributed firewall module instructing one or more communication ports be opened to support an application when the application is activated within the host computing system, a network interface module for sending and receiving data packets over the network between the client computing system, and an NIC control module for processing port command messages received from the distributed firewall module to open one or more communication ports needed to support the application and processing data packets sent and received over the network.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 illustrates an example network-based computing system according to an embodiment of the present invention;

FIG. 2 illustrates a general purpose computing system for implementing various embodiments of the present invention;

FIG. 3 illustrates an example embodiment of a host processing system and an IOP module providing a firewall according to one embodiment of the present invention;

FIG. 4 illustrates an example embodiment of a set of processing modules within a host processing system and an IOP module providing a firewall according to one embodiment of the present invention;

FIG. 5 illustrates a set of firewall control arrays for use in a network-based processing system according to an embodiment of the present invention;

FIG. 6 illustrates a set of firewall command messages used by a host processing system to control operation of an IOP module providing a firewall according to one embodiment of the present invention;

FIGS. 7a-7c illustrate a flowchart of operations within a host processing system according to an embodiment of the present invention; and

FIG. 8 illustrates a flowchart of operations within an IOP module providing a firewall according to one embodiment of the present invention.

### DETAILED DESCRIPTION

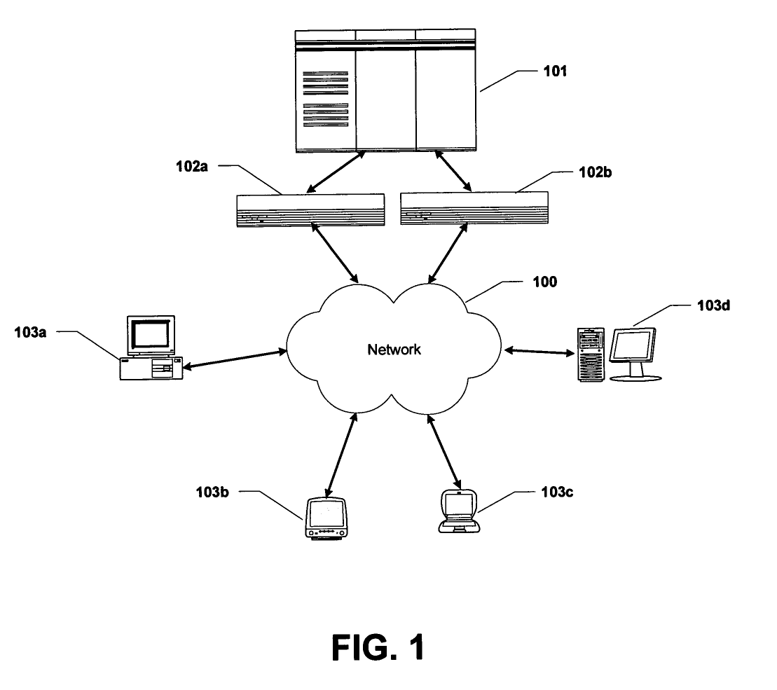

FIG. 1 illustrates an example network-based computing system according to an embodiment of the present invention. In distributed computing environments that utilize firewalls, a host computing system 101 typically communicates with a plurality of client computing systems 103a-103d over a communications network 100. The client computing systems 103a-103d may include computers of various types that run any number of different operating systems. Web servers and e-mail servers are typical examples of such systems. Another example of such systems may provide a more closely coupled client-server processing relationships that provide transaction processing, database access, and other processing services.

Communications between the host computer 101 and the client computers 103a-103d typically uses a standard data transport protocol, such as TCP and UDP protocols, to transport data packets between applications on these computing systems. The various computing systems are assigned one or more unique network addresses, such as an Internet Protocol (IP) address, for use in routing the various data packets between the computing systems. The data transport protocols typically use a set of communications ports associated with a computer's IP address to distinguish data that may be transmitted for various applications located on a computing system. For example, port 80 is a well known port for the Transmission Control Protocol (TCP), and is typically used to provide a hypertext transfer protocol (HTTP) connection to a client requesting an HTTP connection with the server. As such, any HTTP connection request initiated between any client and the server will attempt to establish the communications connection using port 80 on the server. Many other well known ports are used to provide similar services, such as Domain Name Service (DNS) (port 53), Simple Mail Transfer Protocol (SMTP) electronic mail transfer (port 25), Post Office Protocol (POP3) electronic mail retrieval service (port 110), and Dynamic Host Configuration Protocol (DHCP) service (port 547), among others. Port numbers may range between 0 and 65535 under the TCP and UDP communications protocols, where well known ports associated with standard networking services use ports 0 to 1023.

Firewall devices 102a-102b are used as filtering devices and are placed between a computing system 101 and a network 100. Firewall devices 102a-102b receive all data packets sent to a particular IP address and forward only the data packets that are sent using an open port. If a data packet is received using a communications port that is closed, the data packet is simply discarded. As such, applications on computing system 101 only need to process data packets that correspond to a port that has been set to be open to support the application.

Firewall devices 102a-102b may be separate hardware devices as shown in FIG. 1. The firewall functionality may also be implemented as a software-based process running as part of the computing system 101. Finally, the firewall functionality may be embedded within and I/O processor (IOP) that corresponds to a tightly coupled peripheral device for computing system 101. Placing the firewall in separate devices (including IOPs) may reduce the processing workload for a computing system 101 at the cost of additional hardware and complexity. Multiple firewall devices and IOPs 102a-102b may be used if a host computing system 101 utilizes multiple network connections to support its functionality. When multiple firewall devices are used, the open and closed state of the available ports are typically identical.

Prior implementations of firewall devices 102a-102b set the state of a particular port statically under the manual control of a system administrator. As such, a particular port may be set open to support an application that is used occasionally, and as a result, may expose a computing system 101 to receipt of unwanted data packets when the application is not running. Because these ports are typically changed manually by a system administrator, some operating systems set all ports to be open by default rather than require a user to open a particular port when an application is installed for use.

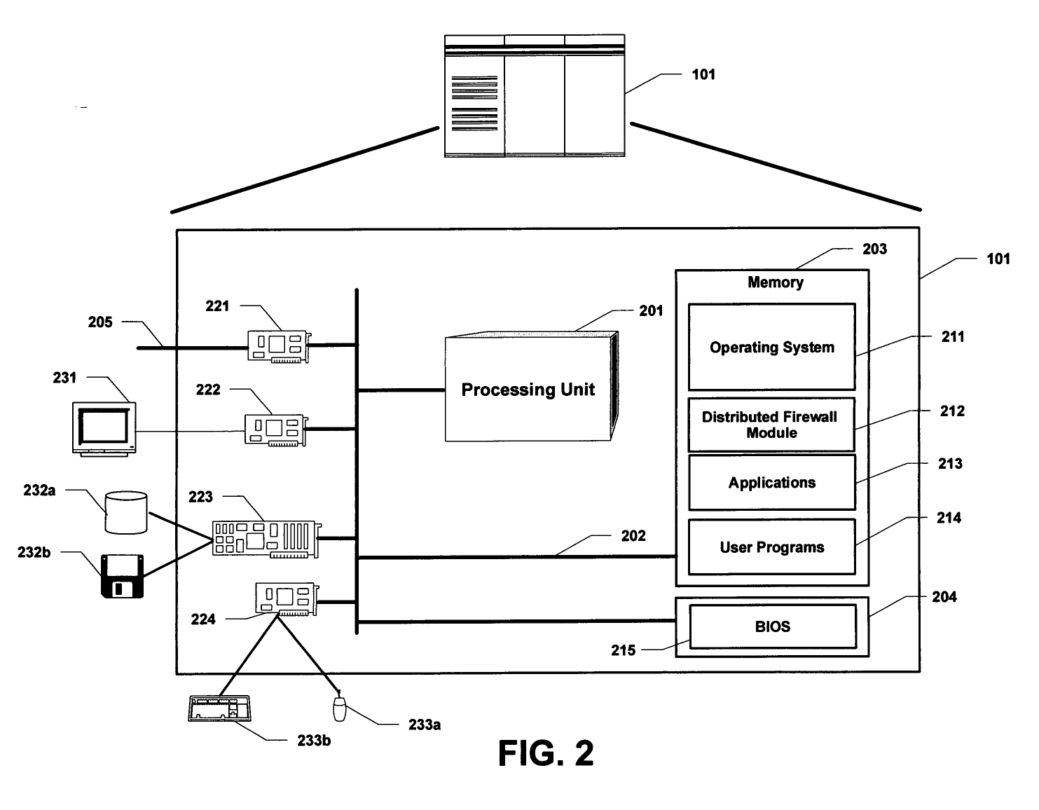

FIG. 2 illustrates a general purpose computing system for implementing various embodiments of the present invention. Those of ordinary skill in the art will appreciate that the computing system 101 may include many more components than those shown in FIG. 2. However, the components shown are sufficient to disclose an illustrative embodiment for practicing the present invention. As shown in FIG. 2, computing system 101 is connected 205 to WAN/LAN 100 (not shown), or other communications network, via network interface unit 221. Those of ordinary skill in the art will appreciate that network interface unit 221 includes the necessary circuitry for connecting computing system 101 to WAN/LAN 100, and is constructed for use with various communication protocols including the TCP protocol. Typically, network interface unit 221 is a card contained within computing system 101.

The computing system 101 also includes processing unit 201, video display adapter 222, and a mass memory, all connected via bus 202. The mass memory generally includes RAM 203, ROM 204, and one or more permanent mass storage devices, such as hard disk drive 232a, a tape drive, CD-ROM/DVD-ROM drive, and/or a floppy disk drive 232b. The mass memory stores operating system 211 for controlling the operation of the programmable computing system 101. It will be appreciated that this component may comprise a general purpose server operating system as is known to those of ordinary skill in the art, such as UNIX, MAC OS X™, LINUX™, or Microsoft WINDOWS XP™. Basic input/output system (“BIOS”) 215 is also provided for controlling the low-level operation of computing system 101.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for providing a host computing system. More specifically, the mass memory stores applications including host application program 213, user programs 214, and distributed firewall module 212.

The computing system 101 also comprises input/output interface 224 for communicating with external devices, such as a mouse 233a, keyboard 233b, scanner, or other input devices not shown in FIG. 2. Likewise, computing system 101 may further comprise additional mass storage facilities such as CD-ROM/DVD-ROM drive and hard disk drive 232a. Hard disk drive 232a is utilized by computing system 101 to store, among other things, application programs, databases, and program data used by various application programs.

The embodiments of the invention described herein are implemented as logical operations in a general purpose computing system. The logical operations are implemented (1) as a sequence of computer implemented steps or program modules running on a computer system and (2) as interconnected logic or hardware modules running within the computing system. This implementation is a matter of choice dependent on the performance requirements of the computing system implementing the invention. Accordingly, the logical operations making up the embodiments of the invention described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto. This software, firmware, or similar sequence of computer instructions may be encoded and stored upon computer readable storage medium and may also be encoded within a carrier-wave signal for transmission between computing devices.

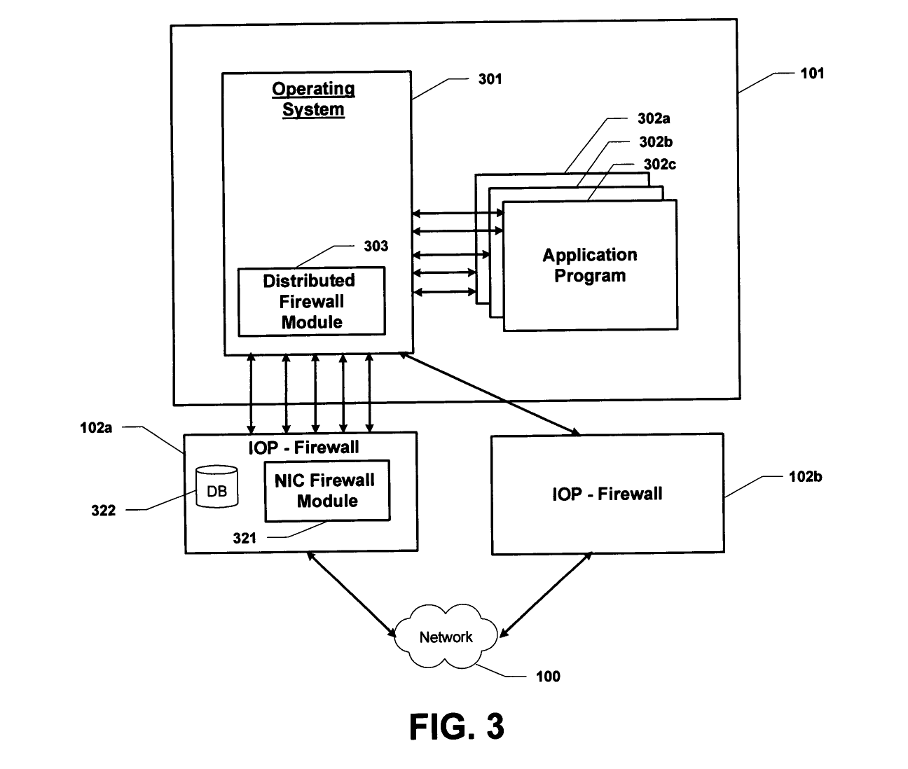

FIG. 3 illustrates an example embodiment of a host processing system and an IOP module providing a firewall according to one embodiment of the present invention. In this example embodiment, host computing system 101 includes in part and operating system 301 a plurality of applications 302a-302c. Operating system 301 includes a distributed firewall module 303 that controls the operation of data packet processing performed in a NIC firewall module 321 that executes within IOP 102a. IOP 102a receives and sends data packets to remote computing systems over network 100.

NIC firewall module 321 receives all incoming data packets from network 100 and determines if the packet is being transmitted using an open port. If the port is not open the data packet is discarded. If the port is open, the data packet may be transmitted to distributed firewall module 303. Distributed firewall module 303 determines which application 302a-302c receives the packet. Outgoing data packets from applications 302a-302c flow along a similar path through distributed firewall module 303 and NIC firewall module 321 to network 100. Distributed firewall module 303 and NIC firewall module 321 together or separately may prevent outgoing data packets from being transmitted when the outgoing port used is closed.

When host computer 101 and IOPs 102a-102b are first brought online, all of the communication ports are set to a closed state. As such, no network data packets are passed from the IOP 102a to host computer 101. These ports remain closed until a particular application 302a is loaded by operating system 301 into memory for execution. When an application 302a is loaded, the application informs the operating system 301 which, if any, communication ports are needed to support the application's functionality. Operating system 301 determines if the application 302a is authorized to perform network communications over the requested ports and informs distributed firewall module 303 which ports are to be opened. Distributed firewall module 303 then instructs the NIC firewall module 321 that one or more ports are now open. Data packets received after these ports are opened are forwarded to distributed firewall module 303 for passage to application 302a. Any errors in operation or receipt of packets to be discarded will be logged in a data file saved within memory 322 in IOP 102a. This log data may be periodically passed to operating system 301 for use by a system administrator as needed.

The communication ports remain open as long as a corresponding application is running on host computer 101. When application 302a terminates operation for any reason (i.e. terminating both abnormally or normally), operating system 301 informs distributed firewall module 303 that the open ports are no longer needed. This updated information causes distributed firewall module 303 to instruct NIC firewall module 321 to close the corresponding open ports. Once the ports are closed, data packets received using these ports are once again discarded. These ports remain closed until an application requiring the ports is loaded causing the above set of events to occur once again. This process applies generally to both UDP-based and TCP-based data communications.

For TCP-based data communications, the data communications protocol utilizes a “connection” between two applications to pass data packets between them. The TCP protocol requires the exchange of a sequence of control packets to establish a connection before data packets are transferred between the two applications. IOP 102a processes the control packets to establish the TCP connection using a particular port number. To establish the connection, control packets need to be forwarded by IOP 102a to host computer 101 for processing. in contrast, data packets transmitted using this port number are to be ignored unless a data connection was previously established. As such, distributed firewall module 303 maintains and IOP 102a utilizes control bits associated with each TCP port that open and close each port to control packets to establish connections as well as open and close these ports to data packets once a connection has been established. When an application 302a is loaded, the control bits associated with the ports used by the application are set to open the ports to control packets. Control packets received by IOP 102a are forwarded to distributed firewall module 303 to establish a TCP connection. Part of establishing this TCP connection includes setting the control bit associated with opening the port used for the connection to data packets. Once the port has been opened to TCP data packets, IOP 102a transmits the TCP data packets to distributed firewall module 303 for forwarding to application 302a.

Because it may be possible an application 302a-302c to have more than one TCP connection request for use of a particular port, operating system 301 instructs distributed firewall module 303 to open a port to data packets when the first connection request using a port is issued. When a second TCP connection request requesting the port is issued, the instruction to open the port to data packets is not needed. When one of the two TCP connections terminates, operating system 301 does not instruct distributed firewall module 303 to close the port to data packets as it is still needed to support the TCP connection remaining. Once all TCP connections that requested a particular port have terminated operation, operating system 301 instructs distributed firewall module 303 to close the port to data packets. One of ordinary skill in the art will recognize that the processing for maintaining a count of the number of connections used a particular port may be located within distributed firewall module 303 rather than in operating system 301 without deviating from the spirit and scope of the present invention.

FIG. 3 illustrates a second IOP 102b. This device is identical to IOP 102a and receives all commands sent by distributed firewall module 303. All IOPs 102a-102b are kept in the same operational state. If an IOP is reset because of an operational error and if a new IOP is brought online, the new IOP begins in a state in which all communication ports are closed. Distributed firewall module 303 sets the state of the ports once the new IOP is operating.

In the preferred embodiment, the state of all of the ports on all IOPs are updated periodically, for example once a minute, in order to ensure that the ports remain in a desired state. In addition to this periodic update, distributed firewall module 303 may transmit a command to a particular IOP 102b to set all of its ports to a desired state as needed.

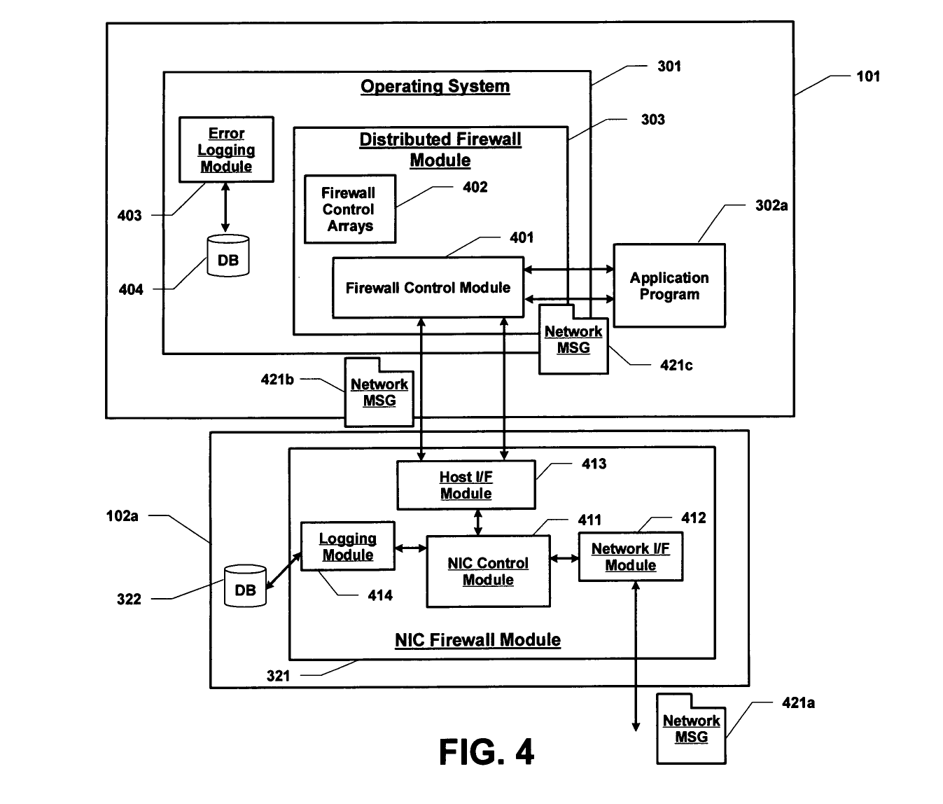

FIG. 4 illustrates an example embodiment of a set of processing modules within a host processing system and an IOP module providing a firewall according to one embodiment of the present invention. In the example embodiment of FIG. 4, host computing system 101 includes application program 302a and operating system 301. Operating system 301 includes distributed firewall module 303, error logging module 403, and error log database 404. Distributed firewall module 303 includes firewall control module 401 and firewall control arrays 402.

Firewall control module 401 corresponds to a processing module that performs the firewall control functions needed to control the operation of IOP 102a. Firewall control module 401 maintains the state of the various communication ports in firewall control arrays 402. The data within firewall control arrays 402 is used to command IOP 102a how to set the state of the communication ports. Error logging module 403 maintains error data received from IOP 102a This error data 404 may include internal errors related to the operation of IOP 102a. This error data may also include a log of data packets processed by IOP 102a that were discarded. This error data 404 may include the IP address of a source and the IP address of the destination of a discarded data packet, the time stamp of the arrival of a discarded packet, packet header and port information for a discarded packet, and similar information relevant to the arrival and rejection of a data packet. As discussed above with respect to FIG. 3, error logging module 403 received a set of error data that has been collected by a logging module 414 within NIC firewall module 321 of IOP 102a. This set of error data may be periodically sent by logging module 414 that is collected as data packets arrive from network 100.

NIC firewall module 321 executes within IOP 102a and includes NIC control module 411, network interface module 412, host interface module 413, and logging module 414. NIC control module 411 performs all operations needed to process incoming and outgoing data packets based upon the state of a particular port being used for the communications. NIC control module 411 receives commands from firewall control module 401, including a copy of firewall control arrays 402, that set the state of the communication ports. NIC control module 411 internally maintains a copy of the firewall control arrays for use in determining the state of a particular port when processing data packets.

Network interface module 412 performs all operations needed to receive data packets from network 100 as well as transmit data packets onto network 100. Network interface module 412 provides any data packet buffering needed to communicate with network 100 as well as provides any communication protocol processing specific to network 100.

Host interface module 413 performs all operations needed by NIC control module 411 to communicate with firewall control module 401. Host interface module 413 performs any processing necessary to support the data connection between NIC control module 411 and firewall control module 401. For example, host interface module 413 may support inter process data communication if NIC firewall module 321 is implemented as software running in host computing system 101. Similarly, host interface module 413 may provide network-type communications between IOP 102a and host computer 101 if the NIC firewall module 321 is implemented as a separate firewall device. Host interface module 413 isolates the operation of NIC control module 411 from the location of the NIC firewall module 321 in either software module, an tightly coupled IOP, or a separate networked device. One of ordinary skill in the art will recognize that the present invention may operate in any of these environments without deviating from the spirit and scope of the present invention.

Logging module 414 receives error messages from NIC control module 411 upon a determination that a data packet is discarded. Logging module may also receive other error messages related to the operation of IOP 102a. Logging module 414 saves these error messages in local data storage 322 for later use. Periodically, logging module 414 organizes the collected error and forwards the data to error logging module 403 for use by a system administrator.

To understand the operation of the interaction of the distributed firewall module 303 and the NIC firewall module 321, an example of a computing system providing data communication connections using the TCP and UDP transport protocols are presented. These two transport protocols are presented for illustrative purposes only and are not meant to limit the scope of the present invention as other transport protocols may operate as part of the present invention.

Both TCP and UDP transport protocols are presented because they differ in scheme of operation. UDP is a connectionless transport protocol, and utilizes only data packets that are sent between a client computer 103a and host computer 101. The TCP transport protocol is a connection-oriented transport protocol and exchanges a sequence of control packets to establish a connection between client computer 103a and host computer 101 (see FIG. 1) before data packets are exchanged between client computer 103a and host computer 101.

For a TCP transport protocol, client computer 103a (not shown) establishes a network connection with host computer 101 by issuing a SYN packet, i.e. a client service request packet, to an IP address associated with host computer 101. The SYN packet provides host computer 101 an IP address and a port number for client 103a and a port ID for a TCP port on host computer 101 for use in the network connection. Host computer 101 responds to the SYN packet with a SYN-ACK packet, i.e. a service response packet. A network connection is established when client 103a returns an ACK packet, i.e., a client connection acknowledgement packet, in response to the SYN-ACK packet.

First, consider a TCP connection between client computer 103a and host computer 101. Client computer 103a transmits a SYN packet 421a that is received by network interface module 412 and passed to NIC control module 411. NIC control module 412 checks the port number referenced in the SYN packet 421a to determine if the particular port is open. As noted above in reference to FIG. 3, a port is open when an application program 302a is active in host computer 101 and has requested that the port be open. This request to open a port is captured by the operating system 301 and is passed to firewall control module 401. Firewall control module 401 maintains the open state within the firewall control arrays 402. In the preferred embodiment, these control arrays 402 are periodically transmitted to NIC control module 411 to inform the NIC control module of the port's open state. The data within these control arrays 402 issued by NIC control module to determine whether the SYN packet 421a is to be discarded or forward to host computer 101 for additional processing. These arrays contain an array for indicating the open/closed state for all TCP ports. These arrays also contain a separate array for indicating the state of each port with respect to acceptance of TCP data packets.

If the NIC control module 411 determines that the SYN packet 421a is to be discarded, it is sent to the logging module 414 for error processing (and counted). If the NIC control module 411 determines the SYN packet 421a references an open port, the SYN packet is forwarded to firewall control module 401 in host computer 101. Host computer 101 generates a SYN-ACK packet 421b that is returned to client computer 103a over network 100. When an ACK packet is returned from client 103a, NIC control module 411 recognizes that it references an open port and forwards it to firewall control module 401. Firewall control module 401 recognizes that the ACK packet has successfully established a connection between client computer 103a and host computer 101 and it now identifies that the particular port used to establish the connection may now receive data packets. Firewall control module 401 sets a control bit within a data array in the firewall control arrays 402 to indicate the port may accept data packets. This updated array is forwarded to NIC control module 411 for use in processing subsequent data packets.

If a data packet is received over a port before the control arrays indicate that the port is open to data packets, the data packets are discarded and logged as an error. This result occurs regardless of whether the particular port is otherwise open. Once the firewall control arrays indicate that data packets are permitted, subsequent data packets 421c (not shown) received from client computer 103a are processed and forwarded by NIC control module 411 through firewall control module 401 to application 302a.

If the above described TCP data connection between application 302a and the application on client computer 103a terminates, operating system 301 informs firewall control module 401 causing the firewall control arrays 402 to be updated to close a port to data packets. This TCP data connection typically terminates when the application on client computer 103a closes the data connection or when the application on client computer 103a terminates. This TCP port used by the data connection is closed to TCP data packets while remaining open to TCP control data packets used to establish a new TCP connection. These updated control arrays 402 are sent to NIC control module 411 to close a port to data packets until another connection is established.

If the above described TCP data connection terminates because application 302a terminates operation, operating system 301 informs firewall control module 401 causing the firewall control arrays 402 to be updated to close a port to data packets as well close the port to connections. Firewall control module 401 updates two separate bits per port used by application 302a within the firewall control arrays 402 to separately close each port both to data packets and to connections. The updated firewall control arrays 402 are transmitted to all IOPs to close the operation of these ports.

A UDP connection utilizes only data packets and as such does not require the establishment of a connection between a client computer 103a and host computer 101 before the data packets are forwarded from NIC control module 411 to firewall control module 401. If the particular port is open for UDP data, the data packets are forwarded. If the particular port is not open, the data packet is sent to the logging module 413 for error processing and counting. The firewall control arrays 402 contain an array separate from the above TCP arrays to indicate the UDP port open/closed state for all UDP ports supported. As noted above, UDP ports used by application 302a are opened when the application is first loaded into the memory of host computer 101. When application 302a terminates operation, the appropriate control bit within the UDP control array is reset to close the port.

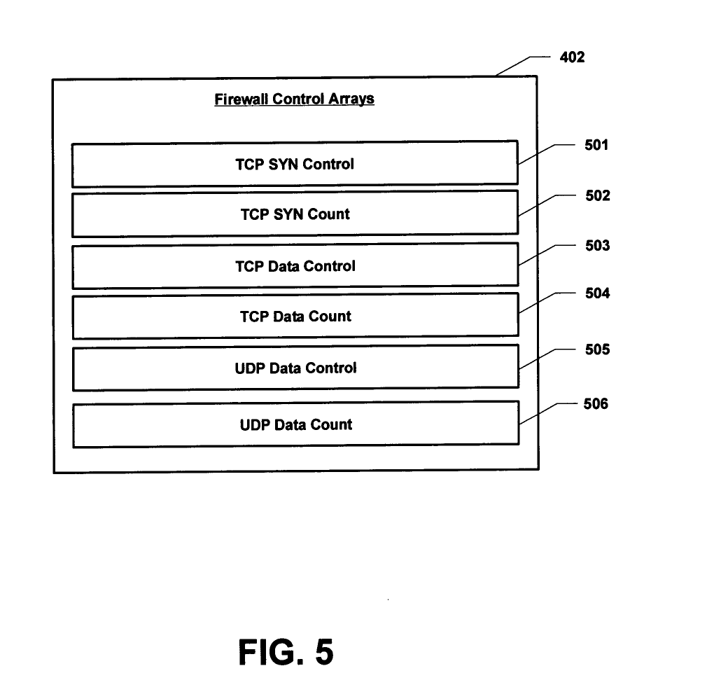

FIG. 5 illustrates a set of firewall control arrays for use in a network-based processing system according to an embodiment of the present invention. To support both TCP and UDP data transport protocols, firewall control arrays 402 include six control arrays that include a TCP SYN control array 501 and a corresponding TCP SYN count array 502, a TCP data control array 503 and a corresponding TCP data count array 504, and a UDP control array 505 and a corresponding UDP count array 506. TCP SYN control array 501 corresponds to an array of 65,536 bits of data in which each bit corresponds to a TCP port number supported by the TCP data transport protocol. When IOP 102a and host computer 101 are first initialized, all of the bits in the TCP SYN control array are reset to zero to indicate that all of the supported ports are in a closed state. When an application 302a is loaded into memory of host computer 101, bits in TCP control array 501 corresponding to TCP ports to be opened for use by application 302a are set to a 1. The bits in the TCP control array 501 that are set to a 1 indicate to NIC control module 411 which ports are open for use to establish a TCP network connection.

TCP SYN count array 502 corresponds to an array of 65,536 words of data in which each word corresponds to a TCP port number supported by the TCP data transport protocol. Each of the words of data in the array 502 may be used to store the number of connections 302a-302c that are currently running that use the particular port. This count value may be used to indicate when a particular port is to be closed when the last connection using the port terminates it operation. The count value is incremented when an connection request is issued on a particular port. Similarly, the count value is decremented when an connection terminates. A separate count value is maintained for each available port.

TCP data control array 503 corresponds to an array of 65,536 bits of data in which each bit corresponds to a TCP port number supported by the TCP data transport protocol. When IOP 102a and host computer 101 are first initialized, all of the bits in the TCP data control array are reset to zero to indicate that all of the supported ports are in a closed state to data packets. When a valid TCP network connection is established between client computer 103a and host computer 101, bits in TCP data array 503 corresponding to TCP ports supporting the connection are set to a 1. The bits in the TCP data array 501 that are set to a 1 indicate to NIC control module 411 which ports are open for use to accept TCP data packets.

TCP data count array 504 corresponds to an array of 65,536 words of data in which each word corresponds to a TCP port number supported by the TCP data transport protocol. Each of the words of data in the array 504 may be used to store the number of TCP network connections that are currently in use on the particular port. This count value may be used to indicate when a particular port is to be closed to data packets when the last TCP network connection using the port terminates it operation. The count value is incremented when a TCP network connection is established using a particular port. Similarly, the count value is decremented when the TCP network connection terminates. A separate count value is maintained for each available port.

UDP data control array 505 corresponds to an array of 65,536 bits of data in which each bit corresponds to a UDP port number supported by the UDP data transport protocol. When IOP 102a and host computer 101 are first initialized, all of the bits in the UDP data control array 505 are reset to zero to indicate that all of the supported ports are in a closed state. When an application 302a is loaded into memory of host computer 101, bits in UDP control array 505 corresponding to UDP ports to be opened for use by application 302a are set to a 1. The bits in the UDP control array 505 that are set to a 1 indicate to NIC control module 411 which ports are open for use to process UDP data packets.

UDP count array 506 corresponds to an array of 65,536 words of data in which each word corresponds to a UDP port number supported by the UDP data transport protocol. Each of the words of data in the array 502 may be used to store the number of applications 302a-302c that are currently running that use the particular UDP port. This count value may be used to indicate when a particular UDP port is to be closed when the last application using the port terminates it operation. The count value is incremented when an application is loaded that used a particular UDP port. Similarly, the count value is decremented when an application terminates. A separate count value is maintained for each available UDP port.

As noted above, the count values from the about three count arrays 502, 504, and 506 may be maintained either within firewall control module 411 and firewall control arrays 402 or within operating system 301. The example of FIG. 5 describes an embodiment in which these count values are maintained within firewall control module 411. The example of FIGS. 3 and 4 describe an embodiment in which these count values are maintained within operating system 301. In the embodiments of FIGS. 3 and 4, the three count arrays 502, 504, and 506 need not be part of firewall control arrays 402.

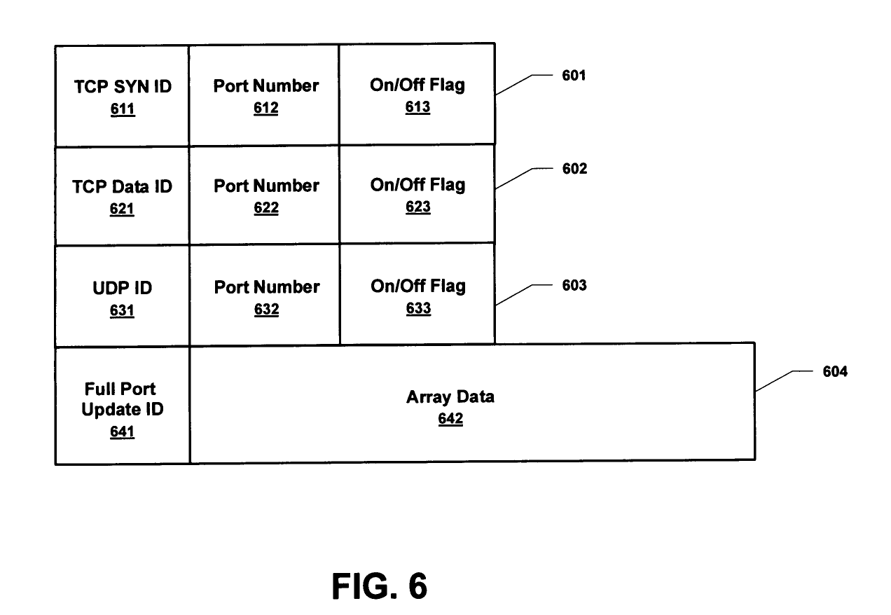

FIG. 6 illustrates a set of firewall command messages used by a host processing system to control operation of an IOP module providing a firewall according to one embodiment of the present invention. When firewall control module 411 instructs NIC control module 421 to set the state of one or more supported ports to a particular state, firewall control module transmits one or more firewall command messages 601-604 to NIC control module 421. The set of firewall control modules 601-604 include a TCP SYN command 601, a TCP data command 602, a UDP data command 603, and a full port update command 604. TCP SYN command 601 contains three fields: a TCP SYN ID field 611 that indicates that the command corresponds to a TCP SYN command, a port number field 612 that indicates the particular TCP port to be opened or closed, and a on/off flag field 613 that contains a single bit of data corresponding to the new port state defined within the TCP SYN control array 501.

TCP data command 602 contains three fields: a TCP data ID field 621 that indicates that the command corresponds to a TCP data command, a port number field 622 that indicates the particular TCP port to be opened or closed to data packets, and a on/off flag field 623 that contains a single bit of data corresponding to the new port state defined within the TCP data control array 503.

UDP data command 603 contains three fields: a UDP ID field 631 that indicates that the command corresponds to a UDP data command, a port number field 632 that indicates the particular UDP port to be opened or closed to UDP data packets, and a on/off flag field 633 that contains a single bit of data corresponding to the new port state defined within the UDP data control array 505.

Full port update command 604 contains two fields: a full port update field 641 that indicates that the command corresponds to a full port update command and an array data field 642 that contains the entire contents of TCP SYN control array 501, TCP data control array 503, and UDP data control array 505. The firewall control module 411 may use the full port update command 604 when an update to all ports on an IOP 102a at the same time. In some embodiments, a full port update command 604 may be periodically transmitted by firewall control module 411 to ensure that the IOP operates in a proper state for all TCP and UDP ports.

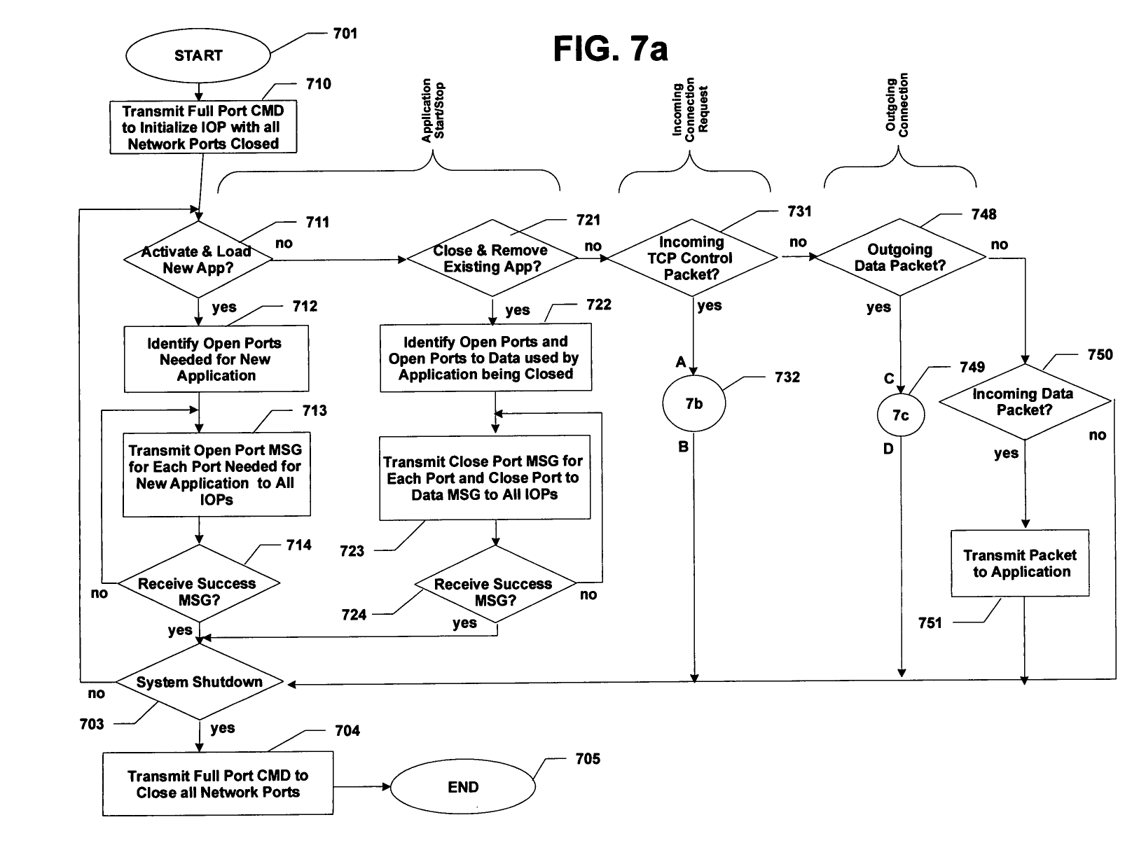

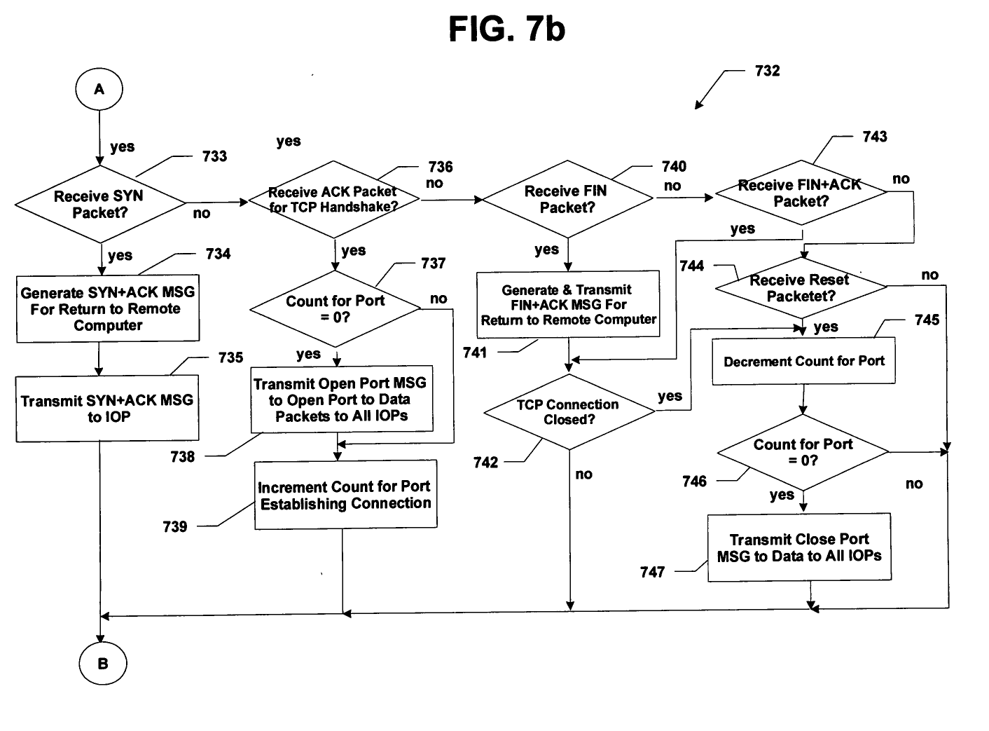

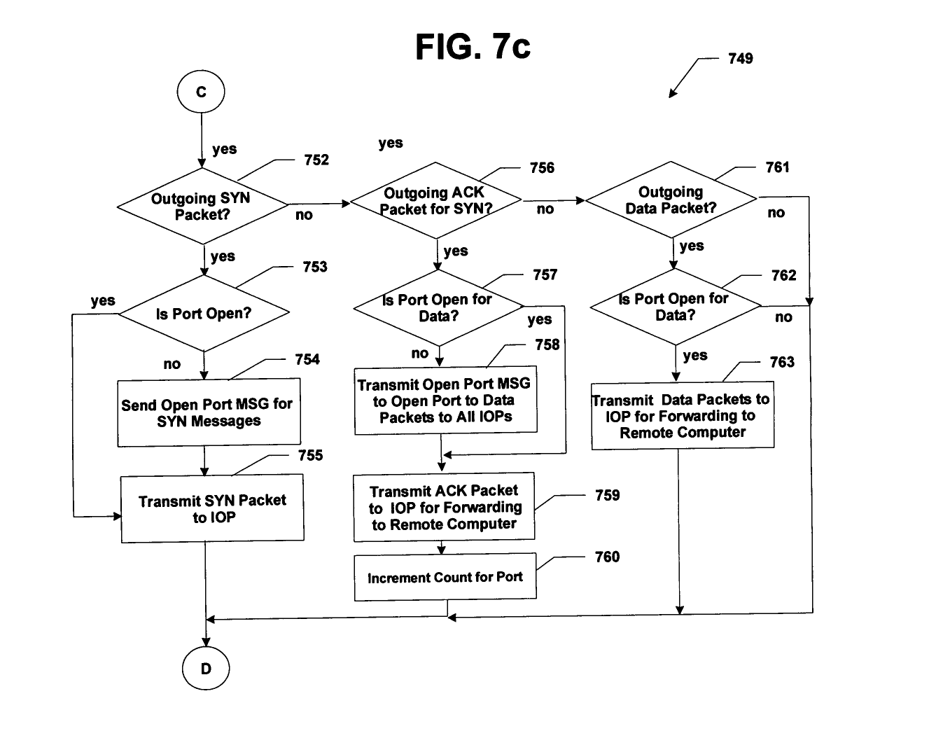

FIGS. 7a-7c illustrate a flowchart of operations within a host processing system according to an embodiment of the present invention. In this example embodiment, the host processing system 101 communicates firewall command messages with IOP 102a in order to provide a distributed firewall with default deny. The processing starts 701 when the host computing 101 is booted and/or brought on-line. Operation 710 is performed as part of the initialization of the host computing system 101 to close all communications ports associated with all IOPs 102 attached to the cost computing system. In operation 710, the host computing system initializes all of the firewall control arrays 402 to indicate the ports are closed and transmits a full port command 604 containing the firewall control arrays 402.

Processing within firewall control module 401 remains within an idle loop formed by test operation 711, test operation 721, test operation 731, test operation 748, test operation 750, and test operation 703 until an application utilizing a communications port is activated in host computing system 101. Operation 711 detects the activation of an application and operation 712 identifies any communication ports that need to be opened to support the application. The identity of these ports is stored into firewall control arrays 402. Operation 713 transmits any open port messages needed to open the communication ports identified within operation 712. As noted above, the ports may be opened using a full port command 604 that sets all of the ports to the status contained within the firewall control arrays 402. The ports may also be opened using a series of individual port commands 601, 603 depending upon the number of ports being opened and an update port status process used by firewall control module 401.

Test operation 714 determines whether the port update command was successfully performed. If not, processing returns to operation 713 to retransmit the port commands 601, 602, or 604 until the desired port state has been set. Test operation 703 determines whether host computing system 101 is being shutdown. If not, the processing returns to test operation 711 to re-enter the idle loop. When test operation 711 does not detect an new application activating, the processing of the idle loop continues to test operation 721.

When test operation 721 detects the closing of an application, operation 722 identifies any communication ports that need to be closed that were used to support the application. The identity of these ports is stored into firewall control arrays 402. Operation 723 transmits any port command messages needed to close the communication ports identified within operation 722. As noted above, the ports may be closed using a full port command 604 that sets all of the ports to the status contained within the firewall control arrays 402. The ports may also be closed using a series of individual port commands 601-603 depending upon the number of ports being closed and an update port status process used by firewall control module 401. Test operation 724 determines whether the port update command was successfully performed. If not, processing returns to operation 723 to retransmit the port commands 601-604 until the desired port state has been set.

If test operation 721 does not detect the closing of an application, the processing within the idle loop continues to test operation 731. When test operation 731 detects receipt of an incoming TCP control packet processing continues to the incoming connection request processing of FIG. 7b 732. This connection request processing begins with test operation 733 determines whether the received data packet corresponds to a SYN packet. If the SYN bit is set, a responsive SYN+ACK message is generated 734 and transmitted 735 to an IOP 102a for forwarding to the remote computer initiating the connection request. The processing then returns to the idle loop at test operation 703.

If test operation 731 does not detect the receipt of a SYN data packet, test operation determines if an ACK packet corresponding to a previously received SYN packet and its responsive SYN+ACK packet has been received. If the ACK packet is received, test operation 737 determines if the count of open connections on the particular port equals zero. If so, an Open Port Message for that port is transmitted 738 to all IOPs to open the port to data packets. This change in the port state will allow future data packets received on the port to be forward to the application supporting the connection. The count of open connections is incremented 739 to indicate the existence of an open TCP connection on the port before processing re-enters the idle loop at test operation 703. If test operation 737 determines that the connection count for the port is not zero, the count of open connections is also incremented 739 to indicate the existence of an additional open TCP connection on the port before processing re-enters the idle loop at test operation 703. An Open Port Message is not transmitted to the IOPs as the particular port is already open to data packets that are supporting existing connections.

If test operation 736 does not detect receipt of an ACK packet corresponding to a prior connection request handshake, test operation 740 detects the receipt of a FIN packet requesting the closing of an existing TCP connection. If a FIN packet is detected, a FIN+ACK message is generated and transmitted 741 to an IOP for forwarding to the requesting remote computer to complete the TCP connection closing process. Test operation 742 then determines if the requested TCP connection is now closed. If not, the processing re-enters the idle loop at test operation 703. If the test operation 742 determines that the particular TCP connection is now being closed, the connection count corresponding the particular port is decremented 745 to indicate the closing of this connection. Then test operation 746 determines if the new value for the count of open connection is equal to zero. If the count has now reached zero, the final open connection on the port is now closing and a Close Port Message is transmitted 747 to all IOPs to close the port to data packets before re-entering the idle loop at test operation 703. If the new count value has not yet zero, at least one other open connection still exists on this port and processing proceeds directly from test operation 746 to the idle loop at test operation 703.

If test operation 740 does not detect a FIN packet, test operation 743 determines if a FIN+ACK packet was received. If a FIN+ACK message was received, processing continues to test operation 742 to determine if the connection is closed as described above. If test operation 743 does not detect receipt of a FIN+ACK packet, test operation 744 determines if a RST packet was received. If a RST packet is detected, processing continues to operation 745 to begin the processing of closing the particular connection on the port as previously discussed. If test operation 744 does not detect a RST packet, the received TCP control packet detected by test operation 731 does not correspond to a supported TCP control packet. As such, processing does nothing more than re-enter the idle loop at test operation 703.

If test operation 731 does not detect an incoming TCP control packet, test operation 748 determines if an outgoing packet is awaiting transmission to a remote computer. If test operation 748 does not detect an outgoing packet, test operation 750 determines if an incoming data packet was received. If an incoming data packet is detected, the data packet is transmitted to the application 751 before re-entering the idle loop at test operation 703. If no incoming data packet is detected by test operation 750, the processing immediately continues through the idle loop at test operation 703.

If test operation 748 detects an outgoing packet, processing continues to outgoing connection processing 749 as shown in FIG. 7c. First, test operation 752 determines if an outgoing packet corresponds to an outgoing SYN packet to initiate a new TCP connection. If test operation 752 detects a SYN packet, test operation 753 determines if the port to support this new connection is open. If test operation 753 determines that the port is not open, an open port message for SYN messages is transmitted to all IOPs and the outgoing SYN packet is transmitted an IOP 102a for forwarding to a remote computer before re-entering the idle loop at test message 703. If test operation 753 determines that the port supporting this connection is already open, the outgoing SYN packet is transmitted an IOP 102a for forwarding to a remote computer before re-entering the idle loop at test message 703.

If test operation 752 does not detect an outgoing SYN packet, test operation 756 determines if an outgoing ACK packet is being sent in response to a received SYN packet. If test message 756 detects an outgoing ACK packet, test operation 757 determines if the port supporting the new connection is open to receipt of data packets. If test operation 757 detects that the port is closed to data packets, an open port message to open the port to data is transmitted to all IOPs 759 and then the ACK packet is transmitted to an IOP 759 for forwarding to a remote computer that sent the SYN packet. If test operation 757 detects that the port is open to data packets, the ACK packet is transmitted to an IOP 759 for forwarding to a remote computer that sent the SYN packet. In both cases, the count of open connections supported by the particular port is incremented to indicate the opening of an additional connection before the processing re-enters the idle loop at test message 703.

If test operation 756 does not detect an outgoing ACK packet is being sent in response to a received SYN packet, test message 761 determines if an outgoing data packet is being sent to a remote computer. If test message 761 detects an outgoing data packet, test operation 762 determines if the port supporting the connection to be used by the data packet is open to transmission of data packets. If test operation 762 detects that the port to be used to transmit the data packet is open to data packets, the data packet is transmitted to an IOP 763 for forwarding to a remote computer that sent the SYN packet before the processing re-enters the idle loop at test message 703. If test operation 762 detects that the port is closed to data packets, the outgoing data packet is ignored and processing re-enters the idle loop at test operation 703. An error condition message may also be generated and logged to capture the attempted transmission of a data packet over a closed port if desired.

If test operation 761 does not detect an outgoing data packet, the type of outgoing packet is not recognized and once again the packet is ignored and the processing re-enters the idle loop at test operation 703. The present invention treats all TCP control information such as FIN and RST as data packets since there must be an open connection for them to occur. In contrast, SYN/SYN+ACK data packets are the part of TCP which deals with connection set up. All other operations require an open data connection to occur, and thus are treated as “data packets” (i.e. FIN, RST, etc.). As may be the case when any error condition is detected, an error condition message may also be generated and logged to capture the attempted transmission of a data packet over a closed port if desired.

Test operation 703 determines whether host computing system 101 is being shutdown. If not, the processing returns to test operation 711 to re-enter the idle loop. When test operation 703 determines that host computing system is being shut down, all communications ports are closed by operation 704 using a full port command 604 and a copy of the firewall control arrays 402 being set to close the ports. Once all of the communications ports are closed, processing may end 705.

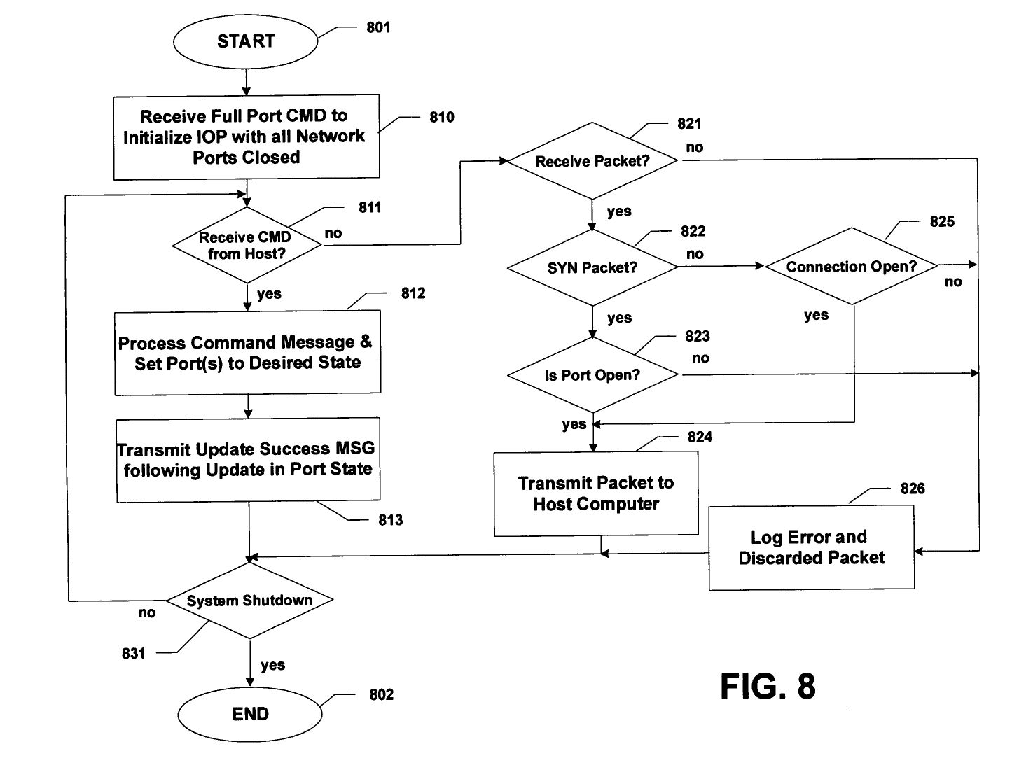

FIG. 8 illustrates a flowchart of operations within an IOP module providing a firewall according to one embodiment of the present invention. Processing within NIC Control Module 411 begins 801 and the IOP 102a receives a Full Port Command 604 that initializes all communication ports to a closed state. Once IOP 102a has been initialized, NIC control module 411 enters an idle loop comprising test operations 811, 821, and 831 while awaiting receipt of a port command message 601-604 from host computing system 101 and receipt of a data packet from network 100.

When test operation 811 determines a port command message 601-604 has been received, the port command message is processed by operation 812 to set one or more communication ports to a desired state. Once the port state has been set, operation 813 informs host computing system 101 that the requested update was successfully applied by transmitting a update success message. Test operation 831 determines if IOP 102a is to shutdown operation and if processing is to end 802. If not, processing returns to the idle loop to await the next command message or data packet.

When test operation 821 detects receipt of a data packet from network 100, test operation 822 determines whether the data packet is a TCP SYN control packet. If the data packet is a TCP SYN control packet, test operation 823 determines whether a port number referenced in the SYN control packet corresponds to an open port on IOP 102a. If the port is open, operation 824 passes the packet to host computing system 101 to attempt to establish a TCP connection with a remote processing system; otherwise the SYN control packet is discarded and processing re-enters the idle loop at test operation 831.

If test operation 822 determines that the incoming data packet is not a TCP SYN control packet, test operation checks to determine whether the incoming data packet is part of a valid TCP connection. If the connection is valid, processing passes to operation 824 to transmit the packet to host computing system 101; otherwise, the incoming data packet is discarded and the idle loop is again re-entered at test operation 831.

While the above processing within IOP 102a performs operations associated with use of a TCP transport protocol, one of ordinary skill in the art will recognize that other data transport protocols, including a UDP transport protocol, may be implemented within IOP 102a without departing from the spirit and scope of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

We claim:

1. A method for providing dynamic firewall services to a host computing system comprising the steps of:
initializing all communication ports to a closed state;
opening a communications port identified by an application for receipt of client service request packets when the application is loaded into memory of the host computing system for execution;
processing network connection service request packets received from a client computing system to generate a service response packet as part of the establishment of a connection between a client computing system and the host computing system;
opening a communication port to data packets for an open port upon receipt of a client acknowledgement packet in response to the service response packet as part of the establishment of the connection between the client computing system and the host computing system;
processing all data packets received on the open port to forward the data packets to the application while the connection exists;
closing the open port to data packets when the established connection ends; and
closing the open port when the application terminates operation.

2. The method according to claim 1, wherein opening a communications port comprises:
transmitting a port command message from the host computing system to an input-output processor (IOP); and
updating a particular communications port to an operational state corresponding to a corresponding port state specified within the port command message.

3. The method according to claim 2, wherein the opening a communications port further comprises:
transmitting an update success message from the IOP to the host computing system indicating that the port command message was successfully applied to the particular communications port.

4. The method according to claim 2, wherein the port command message comprises a full port command to set the state of all communications ports supported by the IOP.

5. The method according to claim 2, wherein the port command message comprises a single port command to set the state of one of the communications ports supported by the IOP.

6. The method according to claim 1, wherein closing a communications port comprises:
transmitting a port command message from the host computing system to an input-output processor (IOP); and
updating a particular communications port to an operational state corresponding to a corresponding port state specified within the port command message.

7. The method according to claim 6, wherein the port command message comprises a full port command to set the state of all communications ports supported by the IOP.

8. The method according to claim 6, wherein the port command message comprises a single port command to set the state of one of the communications ports supported by the IOP.

9. The method according to claim 2, wherein the opening a communications port further comprises:
maintaining a plurality of firewall control arrays within the host computing system containing data corresponding to a desired port state for the communication ports supported by the IOP.

10. The method according to claim 9, wherein data within the firewall control arrays are transmitted by the host computing system to the IOP as part of the port command messages.

11. A machine-readable medium, having encoded thereon program code, wherein, when the program code is executed by a machine, the machine implements a method for providing dynamic firewall services to a host computing system comprising the steps of:
transmitting a port command message to an input-output processor (IOP) to initialize communication ports to a closed port state;
activating and loading an application into memory;
identifying communication ports needed to support the application being loaded into memory of the host computing system;
transmitting a port command message to the IOP instructing the opening of the identified communication ports needed to support the application; and
transmitting a port command message to the IOP instructing the closing of the identified communication ports needed to support the application when the application terminates operation.

12. The machine-readable medium according to claim 11, wherein the method further comprises:
maintaining a plurality of firewall control arrays within the host computing system containing data corresponding to a current port state for the communication ports supported by the IOP.

13. The machine-readable medium according to claim 12, wherein the port command message comprises a full port command to set the state of all communications ports supported by the IOP.

14. The machine-readable medium according to claim 12, wherein the port command message comprises a single port command to set the state of one of the communications ports supported by the IOP.

15. The machine-readable medium according to claim 12, wherein the method further comprises:
receiving an update success message from the IOP indicating that the port command message was successfully applied to the particular communications port.

16. A machine-readable medium, having encoded thereon program code, wherein, when the program code is executed by a input-output processor (IOP), the IOP implements a method for providing dynamic firewall services to a host computing system comprising the steps of:
receiving a port command message from the host computing system to initialize communication ports to a closed port state;
receiving a port command message that instructs the opening of one or more communication ports identified as supporting an application;
receiving a data packet sent to the host computing system over a network using a particular communications port;
forwarding the data packet to the application when the particular communication port identified within the data packet corresponds to an open port; and
receiving a port command message to the IOP instructing the closing of the identified communication ports needed to support the application when the application terminates operation.

17. The machine-readable medium according to claim 16, wherein the method further comprises:
transmitting an update success message from the IOP indicating that the port command message was successfully applied to the particular communications port.

18. The machine-readable medium according to claim 16, wherein the port command message comprises a full port command to set the state of all communications ports supported by the IOP.

19. The machine-readable medium according to claim 18, wherein the method further comprises:
receiving a TCP SYN control packet from a client computing system over the network using a specified communications port;
forwarding the TCP SYN control packet to the host computing system to establish a connection between the host computing system and the client computing system;
receiving a port command message from the host computing system that instructs the opening of one or more communication ports corresponding to the specified communication port to data packets when the connection between the host computing system and the client computing system is established;
receiving a TCP data packet from the client computing system over the network using the specified communications port;
forwarding the TCP data packet to the application when the one or more communication ports corresponding to the specified communication port is open to data packets; and
receiving a port command message from the host computing system that instructs the closing of one or more communication ports that are open to data packets when the connection between the host computing system and the client computing system is terminated.

20. The machine-readable medium according to claim 18, wherein host computing system communicates with the client computing system using a UDP transport protocol.

21. An apparatus for providing dynamic firewall services to a host computing system, the apparatus comprising:
a distributed firewall module executing within the host computing system for controlling the operation of the IOP using port command messages;
an NIC firewall module executing within an input-output processor (IOP) for maintaining a plurality of communications ports associated with communications with a client computing system over a network;
wherein the NIC firewall module comprises:
a host interface module for receiving port command messages from the distributed firewall module instructing one or more communication ports be opened to support an application when the application is activated within the host computing system;
a network interface module for sending and receiving data packets over the network between the client computing system; and
an NIC control module for processing port command messages received from the distributed firewall module to open one or more communication ports needed to support the application and processing data packets sent and received over the network.

22. The apparatus according to claim 21, wherein distributed firewall module comprises:
a firewall control module for generating port command messages used to control the operation of the IOP using the port command messages; and
a firewall control arrays used for storing data corresponding to port operational status for the plurality of communication ports associated with communications between the host computing system and the client computing system over the network.

23. The apparatus according to claim 21, wherein the firewall control module generates port command messages using port operational status data from the firewall control arrays.

24. The apparatus according to claim 22, wherein firewall control module generates port command messages to open one or more communication ports needed to support the application when the application is activated and generates port command messages to close one or more communication ports previously opened to support the application when the application's operation terminates.

25. The apparatus according to claim 24, wherein the host computing system communicates with the client computing system using a UDP transport protocol.
